(19) United States
(12) Patent Application Publication
(10) Pub. No.: US 2018/0107676 A1
(43) Pub. Date: Apr. 19, 2018

(54) CROSS-FOLDER FILE SELECTION METHODOLOGY

(71) Applicant: salesforce.com, inc., San Francisco, CA (US)

(72) Inventor: Darshil Vipul Vora, San Francisco, CA (US)

(73) Assignee: salesforce.com, inc., San Francisco, CA (US)

(21) Appl. No.: 15/294,860

(22) Filed: Oct. 17, 2016

(51) Int. Cl. G06F 17/30; G06F 3/0482; G06F 3/0481

(52) U.S. Cl. CPC G06F 17/30126; G06F 3/04817; G06F 3/0482; G06F 17/3007

(57) ABSTRACT

A method of operating a database system to select multiple files distributed across a plurality of file folders is disclosed. The method generates a first graphical user interface formatted for presentation at a client device and having a first list of selectable files contained in a first file folder maintained by the database system. A first user input is received that identifies at least one selected file from the first list of selectable files, and the database system generates a second graphical user interface formatted for presentation at the client device and having a second list of selectable files contained in a second file folder. A second user input is received that identifies at least one selected file from the second list of selectable files. The database system performs an action involving the selected files from the first list and involving the selected files from the second list.

### TECHNICAL FIELD

Embodiments of the subject matter described herein relate generally to computer systems. More particularly, embodiments of the subject matter relate to methods and systems for selecting and processing files across multiple folders of a cloud-based database system.

### BACKGROUND

A computer-based file system typically includes a hierarchy of folders that are used to organize and store files. A traditional file system allows a user to select one or more files contained in a single folder, wherein the selected files can be manipulated, processed, or otherwise managed as needed. For example, a user can open a chosen file folder, select one or more files in the chosen folder, and upload the selected files to a social media post, attach the selected files to an outgoing email, copy the selected files, move the selected files, or the like.

Conventional file systems and file selection methodologies are limited in that files can only be selected from one folder at a time. Thus, if a user wants to upload or attach multiple files that are distributed across two or more folders, the file selection process must be repeated for each individual folder that contains the desired files. For example, the user must open a first folder, select one or more files in the first folder, upload the selected files, navigate to and open a second folder, select one or more files in the second folder, and upload the newly selected files. This process can be complicated, time consuming, and cumbersome.

Accordingly, it is desirable to have an improved methodology that supports the selection of multiple files across different file folders. An improved methodology and other desirable features and characteristics will become apparent from the subsequent detailed description and the appended claims, taken in conjunction with the accompanying drawings and the foregoing technical field and background.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a simplified schematic representation of an exemplary computer-based database system and a related client device;

FIG. 2 is a flow chart that illustrates an exemplary embodiment of a cross-folder file selection process; and

FIGS. 3-8 depict exemplary graphical user interface (GUI) displays suitable for presentation on a client device in conjunction with the cross-folder file selection process shown in FIG. 2.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein can be realized using code segments or instructions that perform the various tasks. In certain embodiments, the program or code segments are stored in a tangible processor-readable medium, which may include any medium that can store or transfer information. Examples of a non-transitory and processor-readable medium include an electronic circuit, a semiconductor memory device, a ROM, a flash memory, an erasable ROM (EROM), a floppy diskette, a CD-ROM, an optical disk, a hard disk, or the like.

Embodiments of the subject matter described herein generally relate to methods and systems for selecting files, and performing certain actions on the selected files. It should be noted that although one or more embodiments may be described herein in the context of a virtual application in a database system, the subject matter is not necessarily so limited, and in practice, may be implemented in an equivalent manner in any number of different application systems, on-demand systems, cloud computing systems, and the like, and in the context of any type of document, computer file or other resource that includes, presents, or otherwise displays a graphical user interface (GUI) display associated with a user interface capable of receiving input pertaining to the GUI display.

In exemplary embodiments described herein, files that are maintained, managed, or accessed by a cloud-based database system can be selected across a plurality of different folders in a stateful, persistent manner. The database system maintains a suitably formatted file system with multiple folders containing selectable files, and the folders (and the contents of the folders) are displayed to a user of a client system in an on-demand basis. The file selection methodology described here allows the user of the client system to select any number of files contained in any number of folders before initiating an operation that involves the selected files. The database system keeps track of the selected files as the user navigates between different folders, and need not initiate any file manipulating action until after the user has completed the file selection process.

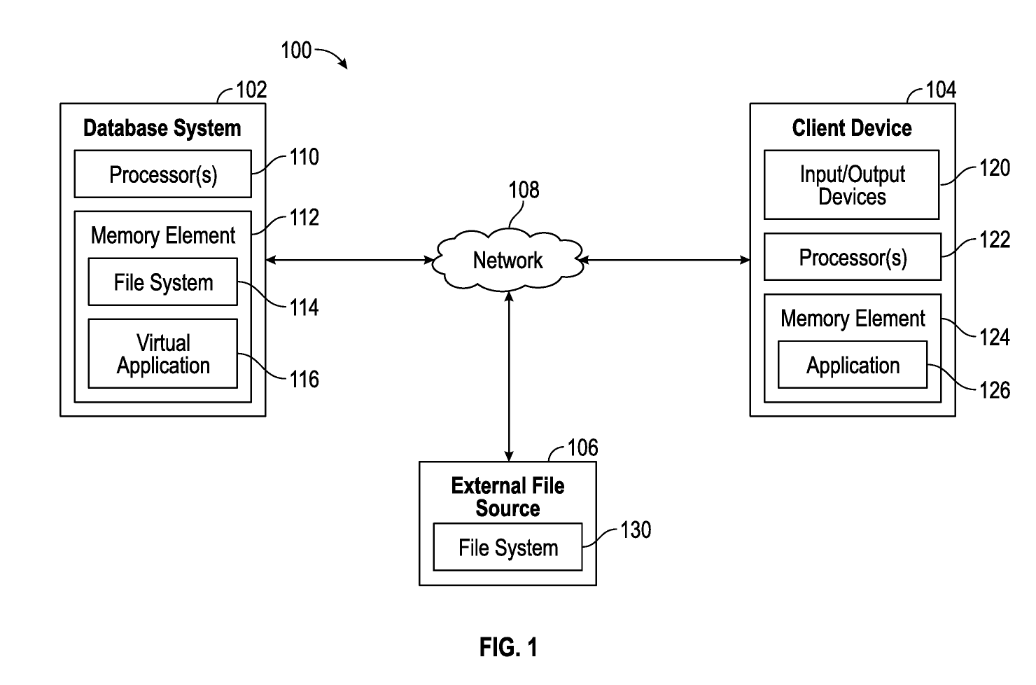

FIG. 1 is a simplified schematic representation that illustrates a computer-based system 100, which includes a computer-based database system 102 and a computer-based client device 104 that is communicatively coupled to the database system 102. Although not always required, the illustrated embodiment of the system 100 also includes an external file source 106, which is communicatively coupled to the database system 102. The database system 102, the client device 104, and the external file source 106 communicate with one another via a suitably configured data communication network 108.

The database system 102 is implemented using computer hardware. In this regard, the database system 102 includes at least one processor 110 and at least one memory element 112 that is communicatively coupled to the processor 110. The processor 110 may be, for example, a central processing unit (CPU), a graphical processing unit (GPU), a field programmable gate array (FPGA), a microcontroller, an application specific integrated circuit (ASIC), or any other logic device or combination thereof. As discussed in further detail below, the processor 110 of the database system 102 executes non-transitory computer-executable instructions stored in the memory element 112, wherein execution of the instructions cause the database system 102 to perform the various operations that support the cross-folder file selection technique.

The memory element 112 can be implemented with any combination of volatile and non-volatile memory. The memory element 112 has non-transitory computer-executable instructions stored thereon, wherein the instructions are configurable to be executed by the processor 110 as needed. The memory element 112 also includes instructions associated with a file system 114 of the database system 102, and instructions associated with a virtual application 116 of the database system 102. The file system 114 includes a plurality of file folders arranged in any desired format, and each of the file folders can accommodate any number of selectable files. The files referenced by the file system 114 can be stored in the memory element 112 and/or in one or more other storage elements (not shown in FIG. 1) that form a part of the database system 102. For example, the memory element 112 can be realized as an internal storage device (such as a hard drive) of the database system 102, which can also support any number of directly attached or networked external storage devices if so desired. The database system 102 is suitably configured and operated to provide an instance of the virtual application 116 to the client device 104 at runtime (or “on-demand”) via the network 108. The virtual application 116 is described in more detail below.

The system 100 can support a plurality of client devices. For simplicity and ease of illustration, FIG. 1 only depicts one client device 104. The client device 104 is implemented as a computer-based hardware component. In this regard, the client device 104 generally includes, without limitation: input/output devices 120; at least one processor 122; and at least one memory element 124. The processor 122 and the memory element 124 can be configured as described above with reference to the counterpart elements of the database system 102. The input/output devices 120 of the client device 104 may include, without limitation: a display element; a speaker; a haptic feedback device; a microphone; a mouse or other pointing device; a touchscreen or touchpad device; a keyboard; a joystick; or any conventional peripheral device.

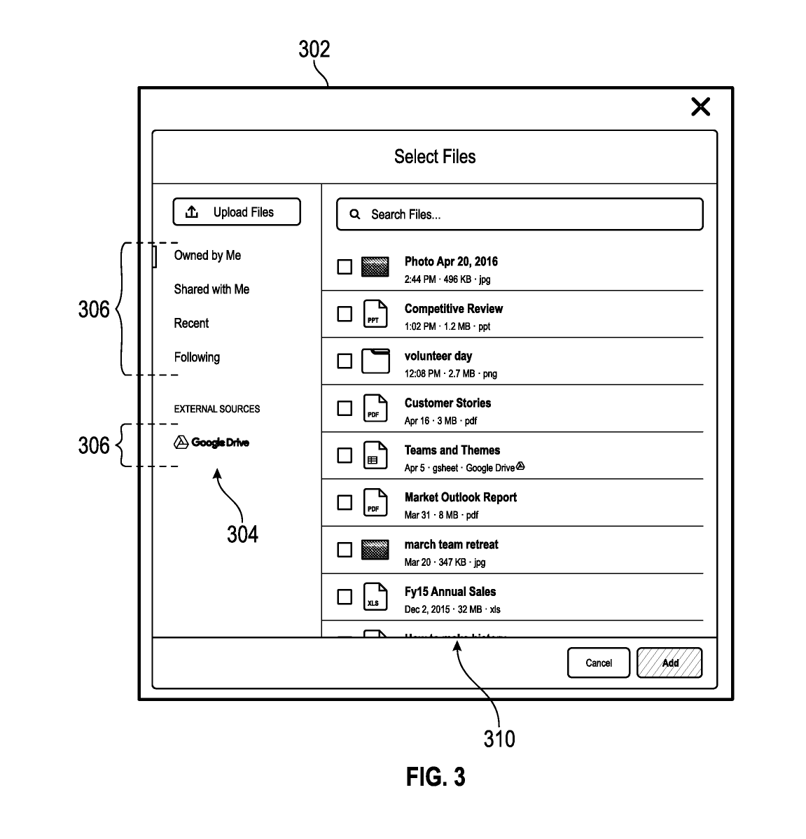

The client device 104 generally represents an electronic device coupled to the network 108 that may be utilized by a user to access the virtual application 116 maintained by the database system 102. In practice, the client device 104 can be realized as any sort of personal computer, mobile telephone, tablet, wearable device, or other network-enabled electronic device that includes a display device, such as a monitor, screen, or another conventional electronic display, capable of graphically presenting data and/or information provided by the virtual application 116, along with a user input device, such as a touchscreen, a touch panel, a mouse, a joystick, a directional pad, a motion sensor, or the like, capable of receiving gestural input from the user of the client device 104. A user manipulates the client device 104 to execute a client application 126 that contacts the database system 102 using a networking protocol, such as the hypertext transport protocol (HTTP) or the like, to access or otherwise initiate an instance of the virtual application 116 presented within the client application 126. As described in greater detail below in the context of FIGS. 3-8, the user manipulates an input device to navigate folders of the file system 114, to select files contained in the folders, and to otherwise carry out operations and functions that involve the selected files.

In certain exemplary embodiments, the client application 126 is a web browser application, and the virtual application 116 of the database system 102 is provided to the user of the client device 104 via the web browser application (in the form of web pages displayed using the web browser application). Thus, the user can interact with GUI displays, GUI control elements, data entry fields, and other interactive elements provided by the web browser application using the input/output devices 120 as needed.

Although the database system 102 and the client device 104 are illustrated as having local memory elements 112, 124, the database system 102 and the client device 104 can also be configured to communicate with at least one external file source 106, which can be realized as a remote storage or memory element having at least one corresponding file system 130 associated therewith. For example, the external file source 106 can be implemented as a cloud storage system or any other memory system maintained by a third party service or maintained by the same entity that maintains the database system 102. The files contained in the external file source 106 can be accessed through the network 108, which may include (without limitation) a wired network, a wireless network (e.g., WiFi, Bluetooth, Zigbee or the like), a cellular network, a satellite network or any other communication network or combination thereof. Further, while the instructions for carrying out the cross-folder file selection methodologies are illustrated as being stored in the respective local memory elements 112, 124, those instructions could also reside in one or more external file sources 106 if so desired.

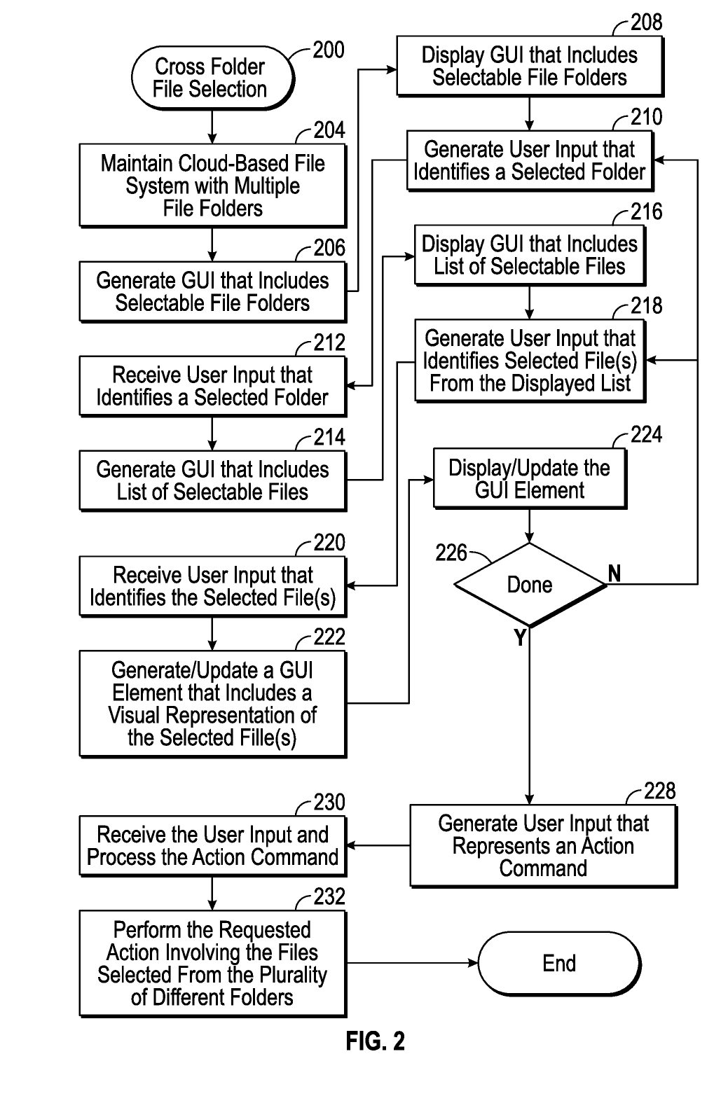

FIG. 2 is a flow chart that illustrates an exemplary embodiment of a cross-folder file selection process 200 that can be supported by the system 100, and FIGS. 3-8 depict exemplary GUI displays suitable for presentation on a client device in conjunction with the cross-folder file selection process 200. The process 200 represents an embodiment of a method of operating a computer-based system to select multiple files distributed across a plurality of different file folders. The various tasks performed in connection with the process 200 may be performed by software, hardware, firmware, or any combination thereof. For illustrative purposes, the following description of the process 200 may refer to elements mentioned above in connection with FIG. 1. In practice, portions of the process 200 may be performed by different elements of the described system, e.g., the database system 102, the client device 104, or the like. It should be appreciated that the process 200 may include any number of additional or alternative tasks, the tasks shown in FIG. 2 need not be performed in the illustrated order, and the process 200 may be incorporated into a more comprehensive procedure or process having additional functionality not described in detail herein. Moreover, one or more of the tasks shown in FIG. 2 could be omitted from an embodiment of the process 200 as long as the intended overall functionality remains intact.

FIG. 2 is generally arranged such that tasks performed by or associated with the database system 102 appear on the left, and tasks performed by or associated with the client device 104 appear on the right. In connection with the process 200, the database system maintains a suitably configured and formatted file system having a plurality of different file folders (task 204), wherein each of the file folders can accommodate any number of selectable files. For the example described here, it is assumed that the file system includes at least two distinct file folders, each containing at least one selectable file. As used herein, a “folder” or a “file folder” represents a logical container, directory, set, group, collection, or pointer for a number of computer-based files. The file system can include a hierarchy of folders and sub-folders, wherein a higher level folder can contain any number of subfolders, a subfolder can contain any number of sub-subfolders, and so on. For the exemplary embodiment described here, the database system 102 can maintain a virtual cloud-based file system 114 that can be accessed and navigated via the virtual application 116.

As used herein, a computer-based “file” is defined in a manner that is consistent with ordinary usage in the computer field. In this regard, the definition provided by The Wikipedia Foundation is applicable: “a computer file is a resource for storing information, which is available to a computer program and is usually based on some kind of durable storage.” Thus, a file handled by the process 200 can have any commonly used file extension for text documents, images, videos, spreadsheets, notes, etc. (such as .docx, .pdf, .xlsx, .txt, .jpg, .tiff, just to name a few). Moreover, a file handled by the process 200 can be a hyperlink, a folder or subfolder, a container file, an executable, an icon, or the like. These particular examples are not intended to be limiting or exhaustive in any way. It should be appreciated that any type of file can be managed by the process 200 as long as the file type is compatible with the database system and the related file system.

The exemplary methodology described here assumes that the database system 102 provides an instance of the virtual application 116 to the client device 104, wherein the virtual application 116 includes functionality that enables the user of the client device 104 to select or pick files that will be subjected to an operation, action, or procedure. For example, the virtual application 116 can be a social networking application that supports file uploading to comment posts, attaching files to email or direct messages, and creating new posts that include files. As another example, the virtual application 116 can be a customer relationship management application or a file archiving application that supports common file manipulation tasks, such as moving files from one folder to another, deleting files, and copying files.

This example assumes that the user of the client device 104 initiates a feature or function of the virtual application 116 that requires viewing or navigating file folders and/or files associated with the file system 114 of the database system 102. To this end, the process 200 generates a suitably configured GUI that is formatted for presentation at the client device 104, wherein the GUI includes selectable file folders or, equivalently, selectable GUI elements or controls that are indicative of selectable file folders (task 206). The GUI can be generated and displayed in response to user activation of a particular button, link, or feature, such as an “Attach” button, an “Upload” button, a “Browse” button, a “Share” button, or the like. In practice, the GUI can be The client device 104 receives and displays the GUI (task 208) such that the user of the client device 104 can navigate to and choose one of the selectable file folders. In this regard, FIG. 3 depicts an exemplary GUI 302 having a folder list 304 that includes a plurality of selectable file folders 306 (this particular embodiment renders the selectable file folders 306 as active text links). The illustrated example includes four selectable file folders 306 that are maintained by the file system 114 of the database system (titled OWNED BY ME, SHARED WITH ME, RECENT, and FOLLOWING), and one selectable file folder 306 that is associated with content stored in an external file source 106 (titled GOOGLE DRIVE).

FIG. 3 depicts the state of the GUI 302 after the user has selected the OWNED BY ME file folder 306—the corresponding label is highlighted or flagged. The process 200 generates a first user input that identifies the selected OWNED BY ME file folder 306 (task 210), and the database system 102 receives and processes the first user input in an appropriate manner (task 212). To this end, the database system 102 generates another GUI that includes a list of selectable files contained in or otherwise associated with the selected OWNED BY ME file folder 306 (task 214). This GUI is formatted for presentation at the client device 104, and is provided to the client device 104 such that the list of selectable files can be displayed to the user (task 216). FIG. 3 depicts the state of the GUI 302 after task 216 has rendered the list of selectable files 310 contained in the OWNED BY ME file folder 306. For this particular embodiment, each selectable file displayed in the GUI 302 includes a checkbox to indicate whether or not it has been selected.

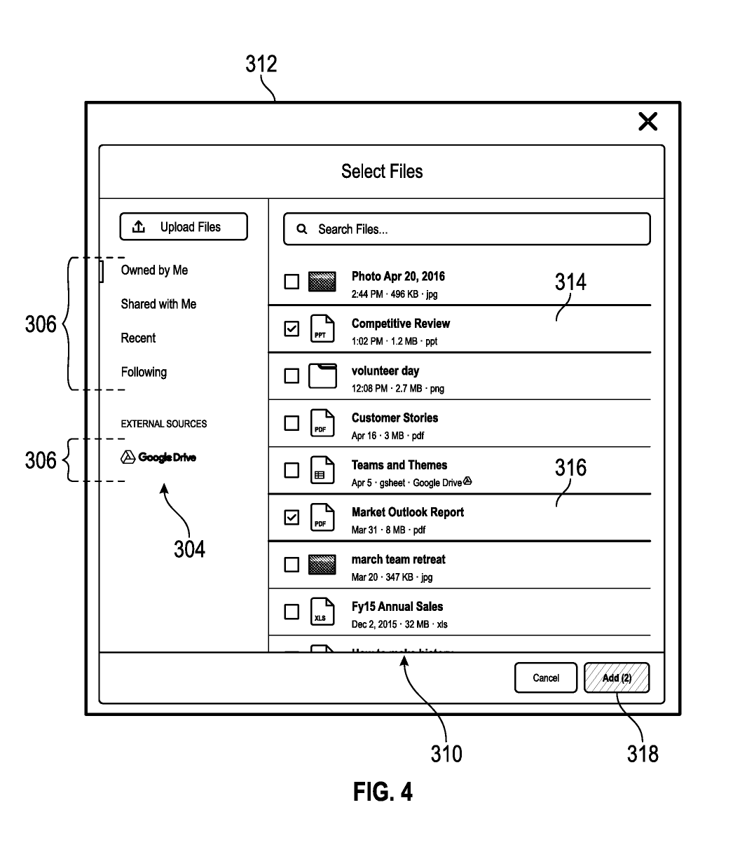

FIG. 4 depicts an updated GUI 312 after selection of a first file 314 and a second file 316 contained in the list of selectable files 310. The selection of these two files 314, 316 is indicated by highlighting and by the presence of a checkmark in the corresponding check boxes. In accordance with the illustrated embodiment, an ADD button 318 is updated to indicate the number of selected files (the label of the ADD button 318 includes the number two in parenthesis). If another file is selected from the list of selectable files 310, then the number rendered with the ADD button 318 will be incremented. Selection of a file and/or activation of an appropriate control element such as the ADD button 318 results in the generation of a second user input that identifies at least one selected file from the list of selectable files 310 (task 218). For the exemplary embodiment described herein, the GUI 312 can be navigated to accommodate selection of any number of the displayed files, and activation of the ADD button 318 generates the second user input to preserve the current selection state at the database system 102. Preserving the selection state in this manner allows the user to navigate to a different folder or subfolder and select additional files if so desired.

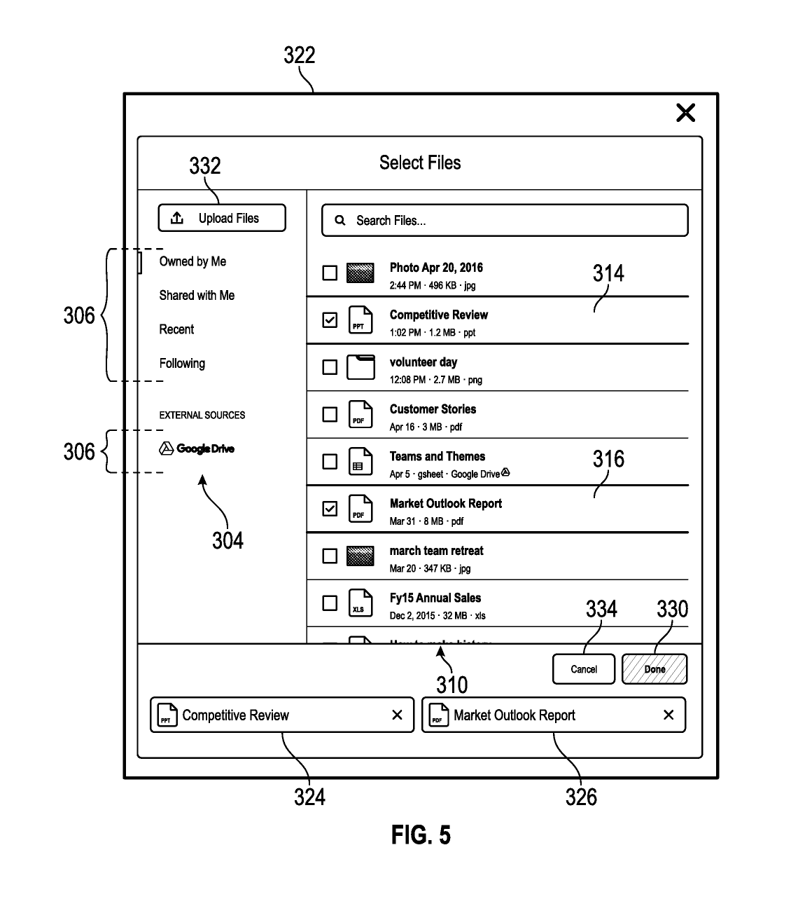

The database system 102 receives the second user input, which identifies the selected file(s), and updates the corresponding selection state to save metadata, pointers, or flags associated with the selected file(s). The database system 102 generates or updates a GUI element that includes a visual representation of the selected file(s) (task 220), and communicates with the client device 104 to display or update the GUI element (task 224). FIG. 5 depicts an updated GUI 322 that confirms the selection of the two files 314, 316. The GUI 322 includes a selected file GUI element 324 corresponding to the selected file 314, and another selected file GUI element 326 corresponding to the selected file 316. The arrangement and format of the selected file GUI elements 324, 326 can vary from one embodiment to another. For this particular embodiment, each selected file GUI element 324, 326 includes, without limitation: a descriptive label (e.g., the name of the file); an icon (e.g., a thumbnail image, a file type icon, or the like); and a deselection control element (e.g., an “X” button as shown, a CANCEL button, or the like). The selected file GUI element(s) serve as a reminder and confirmation of which files have already been selected.

If the user is done with the file selection procedure (the “Yes” branch of query task 226), then the process 200 generates a third user input that represents an appropriate action command (task 228). Referring again to FIG. 5, the third user input can be generated in response to activation of the DONE button 330, in response to activation of the UPLOAD FILES button 332, in response to activation of the CANCEL button 334, or the like. If additional files need to be selected (the “No” branch of query task 226), then the process 200 repeats at least some of the routine described above. As one example, the user can select one or more additional files from the same list of selectable files 310 contained in the GUI 322 (see FIG. 5). In this regard, the “No” branch of query task 226 can lead back to task 218 to accommodate selection of one or more files from the currently displayed list. As another example, the user can navigate to a different file folder 306 (i.e., one other than the OWNED BY ME file folder 306) or navigate to a subfolder of the OWNED BY ME file folder 306 to generate a new displayed list of selectable folders. To this end, the “No” branch of query task 226 can lead back to task 210 to accommodate selection of a new folder or subfolder. Thereafter, folder navigation, display of selectable files, and updating of the selected file GUI elements can be carried out as described above.

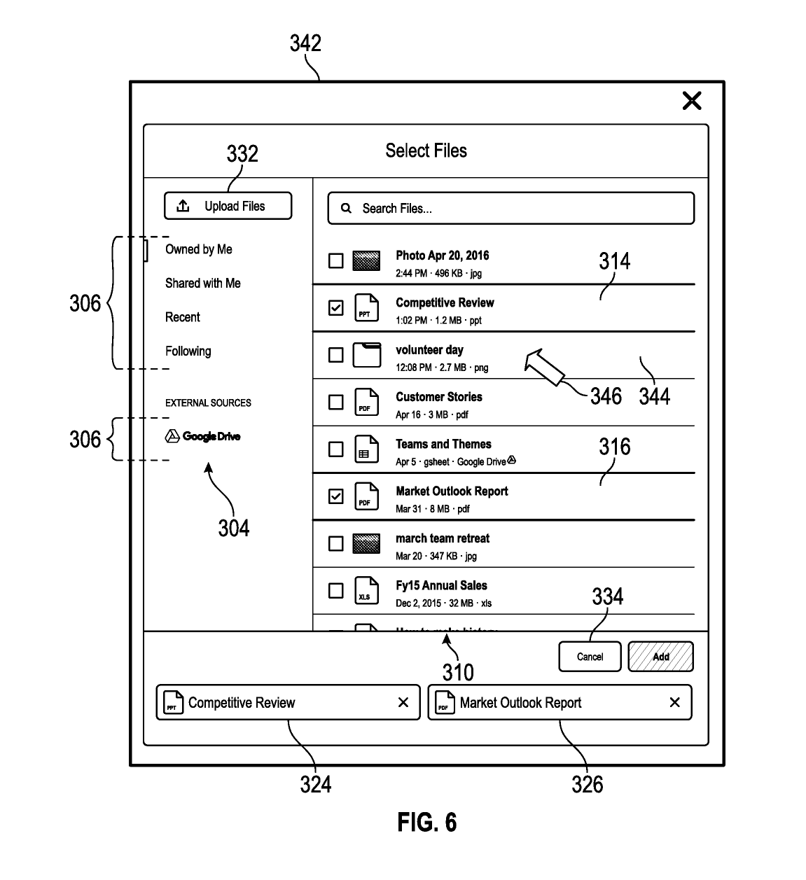

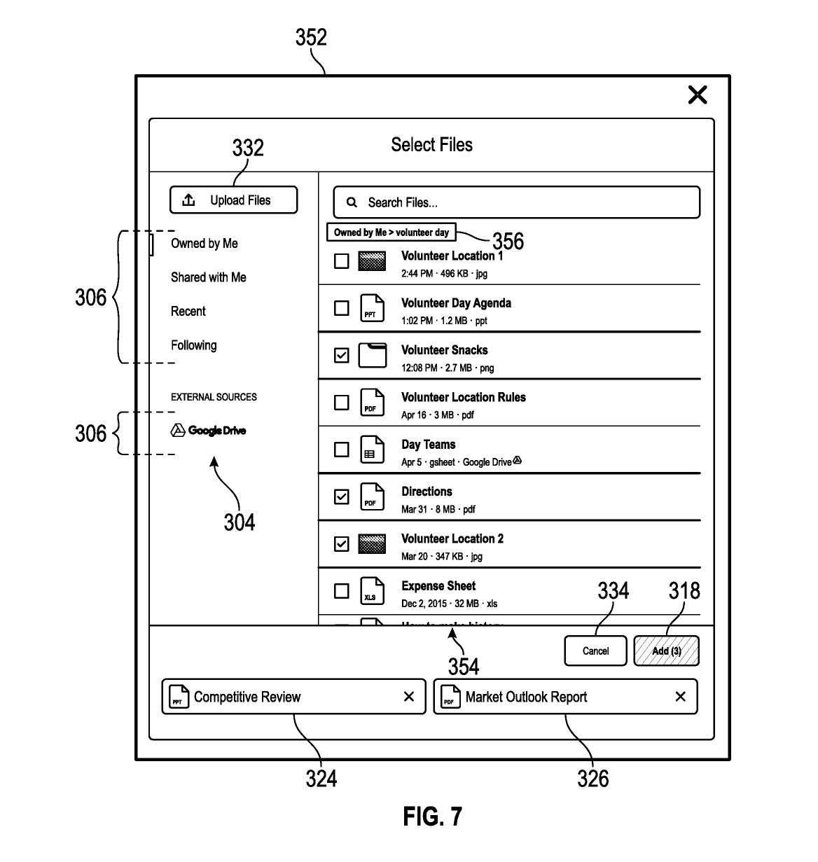

FIG. 6 depicts an updated GUI 342 that corresponds to the selection of a subfolder contained in the list of selectable files 310. More specifically, FIG. 6 illustrates the selection of the VOLUNTEER DAY subfolder 344 via a cursor 346 or other pointing mechanism. Selection of the VOLUNTEER DAY subfolder 344 causes the database system 102 to generate and provide an updated GUI 352 that includes a list of selectable files 354 contained in the VOLUNTEER DAY subfolder 344 (see FIG. 7). The GUI 352 also contains a breadcrumb element 356 that indicates the current file path, file location, folder hierarchy, or the like. For this example, the breadcrumb element 356 indicates that the displayed files are contained in the VOLUNTEER DAY subfolder 344, which is contained in the OWNED BY ME file folder 306. The GUI 352 reflects a state after selection of three files contained in the VOLUNTEER DAY subfolder 344. Accordingly, the ADD button 318 is rendered once again, showing that three files have been selected.

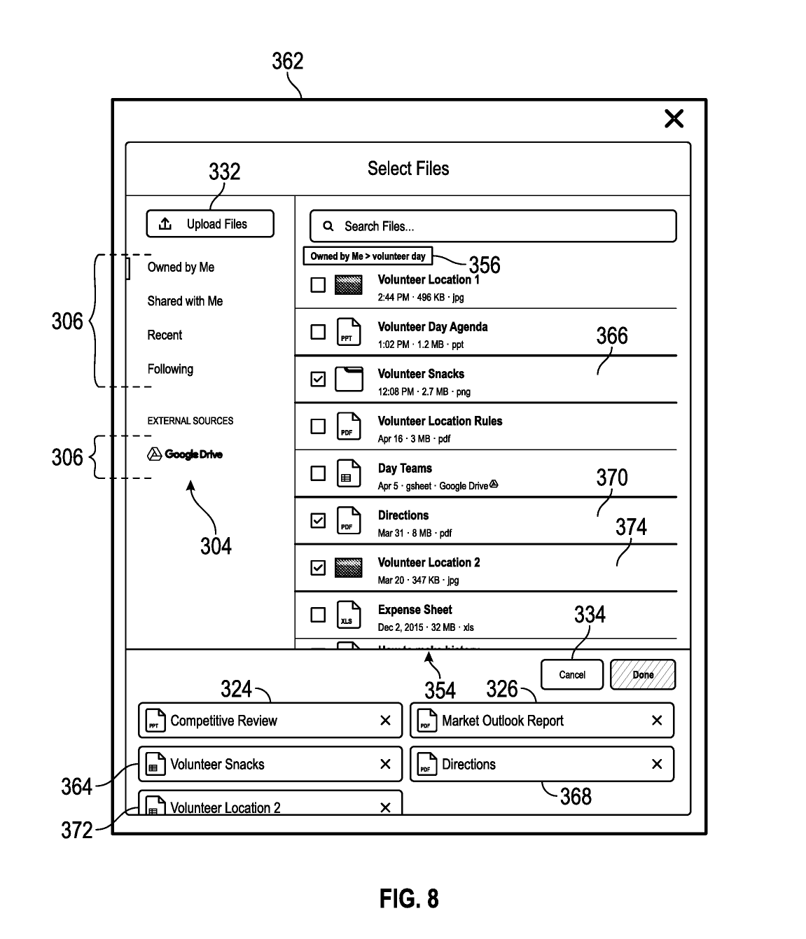

FIG. 8 is similar to FIG. 5 in that it depicts an updated GUI 362 that confirms the selection of the three files contained in the VOLUNTEER DAY subfolder 344. The GUI 322 includes a selected file GUI element 364 corresponding to the selected file 366, another selected file GUI element 368 corresponding to the selected file 370, and yet another selected file GUI element 372 corresponding to the selected file 374. Notably, the GUI 362 now includes five selected file GUI elements that indicate the five selected files, even though two of the five were previously added. This methodology allows the user to continue adding different files distributed across a plurality of file folders until the desired file operation is initiated.

It should be appreciated that the database system 102 can generate and provide any number of GUIs for rendering at the client device 104, and that the client device can generate and provide any number of user inputs that identify selected folders and selected files in the manner described above. Thus, the file selection methodology can be repeated for different files, different file folders, and/or different file subfolders (whether they are maintained by the database system 102 and/or maintained at an external file source),

Referring back to FIG. 2, when file selection is complete (the “Yes” branch of query task 226), the process generates a user input that initiates the desired action, procedure, or activity that involves the selected files. This example assumes that the database system 102 receives the user input and processes the associated action command (task 230), which causes the database system 102 to perform the requested action that involves the files selected from the multiple folders and/or subfolders (task 232). The action performed can be any operation or activity that involves selected files, including, without limitation: a delete action, a copy action, a move action, an attach action, an upload action, or a share action.

The methodology described above enables the database system 102 to receive file selection instructions that identify a plurality of selected files that are distributed across a plurality of file folders, which may be associated with cloud-based files and/or locally stored files in some embodiments. As explained above, the file selection instructions originate from an application of the client device 104 (e.g., a web browser application that supports a virtual application 116 provided by the database system 102). The mechanism used to preserve the file selection state and carry out the desired action can vary from one embodiment to another. In accordance with certain embodiments, the database system 102 saves pointers to the selected files, and the actual processing or handling of the referenced files is delayed until the action command is received. In accordance with other embodiments, the database system 102 can take action in response to the selection of files and perform operations in the background in an anticipatory manner. For example, if the user is uploading files to a social media post, the database system 102 can start uploading selected files in the background while the user continues selecting additional files to upload. Moreover, files can be identified in a continuous manner as they are selected (to accommodate “pre-processing” by the database system 102) or they can be identified in a collective manner after the user indicates that he is finished selecting files, as described above with reference to FIGS. 3-8.

The cross-folder file selection methodology described above is appropriate for use with a cloud-based file system because traditional limitations and restrictions imposed by the client device operating system, web browser application, and local applications can be easily overcome. In certain implementations, however, the cross-folder file selection methodology can be used to select files stored locally on the client device. To this end, the virtual application 116 and/or the client application 126 may need to be configured and designed to support the techniques and schemes outlined above. For example, the database system 102 can be suitably configured to save pointers or references to client device files that have been selected, using features of the virtual application 116 or the client application 126 rather than the standard file explorer or local file system.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method of operating a computer-based database system, the method comprising:
maintaining, by the database system, a file system comprising a plurality of folders, each of the plurality of folders containing at least one selectable file;
receiving file selection instructions at the database system, the file selection instructions identifying a plurality of selected files distributed across the plurality of folders; and
performing, by the database system, an action involving the plurality of selected files.

2. The method of claim 1, wherein the received file selection instructions originate from an application of a client device.

3. The method of claim 1, wherein at least one of the plurality of folders contains at least one selectable file stored at an external file source.

4. The method of claim 1, wherein the step of receiving file selection instructions comprises:
receiving, at the database system, a first user input that identifies a first selected folder from the plurality of folders;
generating, by the database system, a first graphical user interface that includes a first list of selectable files contained in the first selected folder;
receiving, at the database system, a second user input that identifies a second selected folder from the plurality of folders;
generating, by the database system, a second graphical user interface that includes a second list of selectable files contained in the second selected folder; and
receiving, at the database system, a third user input that identifies at least one selected file from the first list of selectable files and at least one selected file from the second list of selectable files.

5. The method of claim 1, wherein the step of receiving file selection instructions comprises:
receiving, at the database system, a first user input that identifies a first selected folder from the plurality of folders;
generating, by the database system, a first graphical user interface that includes a first list of selectable files contained in the first selected folder;
receiving, at the database system, a second user input that identifies at least one selected file from the first list of selectable files;
receiving, at the database system, a third user input that identifies a second selected folder from the plurality of folders;
generating, by the database system, a second graphical user interface that includes a second list of selectable files contained in the second selected folder; and
receiving, at the database system, a fourth user input that identifies at least one selected file from the second list of selectable files.

6. The method of claim 1, wherein the action performed comprises a delete action, a copy action, a move action, an attach action, an upload action, or a share action.

7. The method of claim 1, further comprising:
generating, by the database system, a graphical user interface element that includes a visual representation of files selected from the plurality of folders.

8. The method of claim 7, wherein the visual representation comprises, for each of the files selected from the plurality of folders:
a descriptive label;
an icon; and
a deselection control element.

9. A computer-based database system comprising a memory element and a processor device communicatively coupled to the memory element, the memory element having computer-executable instructions stored thereon and configurable to be executed by the processor to cause the database system to:
maintain a file system comprising a plurality of folders, each of the plurality of folders containing at least one selectable file;
provide an instance of a virtual application to a client device via a network;
receive file selection instructions associated with the instance of the virtual application from the client device, the file selection instructions identifying a plurality of selected files distributed across the plurality of folders; and
perform an action involving the plurality of selected files in response to receiving a command associated with the instance of the virtual application from the client device.

10. The database system of claim 9, further comprising an external file source, wherein at least one of the plurality of folders contains at least one selectable file stored at the external file source.

11. The database system of claim 9, wherein the computer-executable instructions are configurable to cause the database system to:
receive a first user input that identifies a first selected folder from the plurality of folders;
generate a first graphical user interface that includes a first list of selectable files contained in the first selected folder;
receive a second user input that identifies a second selected folder from the plurality of folders;
generate a second graphical user interface that includes a second list of selectable files contained in the second selected folder; and
receive a third user input that identifies at least one selected file from the first list of selectable files and at least one selected file from the second list of selectable files.

12. The database system of claim 9, wherein the computer-executable instructions are configurable to cause the database system to:
receive a first user input that identifies a first selected folder from the plurality of folders;
generate a first graphical user interface that includes a first list of selectable files contained in the first selected folder;
receive a second user input that identifies at least one selected file from the first list of selectable files;
receive a third user input that identifies a second selected folder from the plurality of folders;
generate a second graphical user interface that includes a second list of selectable files contained in the second selected folder; and
receive a fourth user input that identifies at least one selected file from the second list of selectable files.

13. The database system of claim 9, wherein the action performed comprises a delete action, a copy action, a move action, an attach action, an upload action, or a share action.

14. The database system of claim 9, wherein the computer-executable instructions are configurable to cause the database system to generate a graphical user interface element that includes a visual representation of files selected from the plurality of folders.

15. A method of operating a computer-based database system to select multiple files distributed across a plurality of file folders, the method comprising:
generating, by the database system, a first graphical user interface formatted for presentation at a client device and comprising a first list of selectable files contained in a first file folder maintained by the database system;
receiving, at the database system, a first user input that identifies at least one selected file from the first list of selectable files;
generating, by the database system, a second graphical user interface formatted for presentation at the client device and comprising a second list of selectable files contained in a second file folder maintained by the database system;
receiving, at the database system, a second user input that identifies at least one selected file from the second list of selectable files; and
performing, by the database system, an action involving the at least one selected file from the first list of selected files and involving the at least one selected file from the second list of selected files.

16. The method of claim 15, further comprising:
receiving, at the database system, a third user input that represents a command to perform the action, wherein the performing is initiated in response to receiving the third user input.

17. The method of claim 15, wherein the first user input and the second user input originate from an application of the client device.

18. The method of claim 15, wherein the action performed comprises a delete action, a copy action, a move action, an attach action, an upload action, or a share action.

19. The method of claim 15, further comprising:
generating, by the database system, a graphical user interface element that includes a visual representation of the at least one selected file from the first list of selectable files and the at least one selected file from the second list of selectable files.

20. The method of claim 19, wherein the visual representation comprises, for each selected file:
a descriptive label;
an icon; and
a deselection control element.
